(19) United States
(12) Patent Application Publication
(10) Pub. No.: US 2022/0067761 A1
(43) Pub. Date: Mar. 3, 2022

(54) GAMIFIED MARKET RESEARCH SURVEY INTERFACE

(71) Applicant: SUZY, INC., New York, NY (US)

(72) Inventors: Chee Seng Sim, Brooklyn, NY (US); Nicolas Gauchat, Jersey City, NJ (US); William Shawn Mansfield, Wilmington, NC (US); Zachary Krepps, Wilmington, NC (US); Jonathan Brad Gulick, Pennington, NJ (US); Mary Katherine Kagaoan, Brooklyn, NY (US); Avi Savar, New York, NY (US); Matthew Britton, Brooklyn, NY (US)

(21) Appl. No.: 17/346,429

(22) Filed: Jun. 14, 2021

Related U.S. Application Data
(60) Provisional application No. 63/073,875, filed on Sep. 2, 2020.

(51) Int. Cl. G06Q 30/02; G06F 3/0481

(52) U.S. Cl. CPC G06Q 30/0203; G06F 3/04817; G06Q 30/0209

(57) ABSTRACT

Techniques for generating and presenting a market research survey interface are disclosed. The techniques include: generating a graphical user interface (GUI) for a market research survey, the GUI including a grid of visual tiles; detecting a user selection of a visual tile; and in response to the user selection of the visual tile, presenting a market research survey question from multiple market research survey questions.

### RELATED APPLICATIONS

This application claims the benefit of U.S. Provisional Patent Application Ser. No. 63/073,875, titled “Gamified Market Research Survey Interface,” filed Sep. 2, 2020, which is hereby incorporated by reference in its entirety.

### BACKGROUND

Market research surveys allow marketers to pose questions and gather information from respondents. The information gathered in market research surveys may help in many different ways, such as determining features for products and services, optimizing marketing strategies, etc. However, market researchers often struggle to keep respondents engaged with the survey process. For example, prior user interfaces for market research include: infinite scrolling; left/right swiping; and one-screen-at-a-time. These approaches may be perceived as unintuitive and/or boring for users, thus resulting in decreased user satisfaction and engagement. In general, an unengaged respondent may provide unhelpful answers, skip questions, and/or drop off a survey altogether.

Approaches described in this section have not necessarily been conceived and/or pursued prior to the filing of this application. Accordingly, unless otherwise indicated, approaches described in this section should not be construed as prior art.

### TECHNICAL FIELD

The present disclosure relates generally to graphical user interfaces for computer-based market research survey systems.

### SUMMARY

One or more embodiments described herein include a graphical user interface (GUI) for market research surveys that is designed to make the survey experience more enjoyable for users, increasing engagement and thereby improving the amount and/or quality of survey responses provided. One or more features described herein are designed to appeal to aspects of human psychology and behavior. The GUI may be designed to provide a “gamified” experience, i.e.. an experience that the user experiences as a game with objectives and rewards for completing those objectives.

In general, in one aspect, one or more non-transitory computer-readable media store instructions that, when executed by one or more processors, cause the one or more processors to perform operations including: generating a graphical user interface (GUI) for a market research survey, the GUI including a grid of multiple visual tiles; detecting a user selection of a first visual tile in the multiple visual tiles; and in response to the user selection of the first visual tile, presenting a first market research survey question from multiple market research survey questions.

The operations may further include: in response to a user answering the first market research survey question, presenting an animation in the GUI that replaces the first visual tile with a second visual tile. The operations may further include: in response to a user answering market research survey questions for a first row of visual tiles in the grid, presenting an animation in the GUI that replaces the first row of visual tiles with a second row of visual tiles. The operations may further include: detecting completion of a game objective associated with the market research survey, the game objective including one or more of (a) answering market research survey questions for an entire row of visual tiles in the grid or (b) answering market research survey questions for an entire column of visual tiles in the grid; and presenting an animation in the GUI indicating completion of the game objective. The operations may further include: associating one or more hidden bonuses with a subset of the multiple visual tiles, according to an intermittent reinforcement schedule. The operations may further include: storing data indicating a binding of the first visual tile to the market research survey question; detecting a user command to proceed with the market research survey without answering the first market research survey question; and in response to a subsequent user selection of the first visual tile, again presenting the first market research survey question. The operations may further include: based at least on content of a user response to the first market research survey question, assigning a second market research survey question from the multiple market research survey questions to a second visual tile in the multiple visual tiles. The operations may further include: replacing visual tiles in the multiple visual tiles as a user answers questions associated with the multiple visual tiles, until an end condition of the market research survey is satisfied.

In general, in one aspect, a method includes: generating a graphical user interface (GUI) for a market research survey, the GUI including a grid of multiple visual tiles; detecting a user selection of a first visual tile in the multiple visual tiles; and in response to the user selection of the first visual tile, presenting a first market research survey question from multiple market research survey questions.

The method may further include: in response to a user answering the first market research survey question, presenting an animation in the GUI that replaces the first visual tile with a second visual tile. The method may further include: in response to a user answering market research survey questions for a first row of visual tiles in the grid, presenting an animation in the GUI that replaces the first row of visual tiles with a second row of visual tiles. The method may further include: detecting completion of a game objective associated with the market research survey, the game objective including one or more of (a) answering market research survey questions for an entire row of visual tiles in the grid or (b) answering market research survey questions for an entire column of visual tiles in the grid; and presenting an animation in the GUI indicating completion of the game objective. The method may further include: associating one or more hidden bonuses with a subset of the multiple visual tiles, according to an intermittent reinforcement schedule. The method may further include: storing data indicating a binding of the first visual tile to the market research survey question; detecting a user command to proceed with the market research survey without answering the first market research survey question; and in response to a subsequent user selection of the first visual tile, again presenting the first market research survey question. The method may further include: based at least on content of a user response to the first market research survey question, assigning a second market research survey question from the multiple market research survey questions to a second visual tile in the multiple visual tiles. The method may further include: replacing visual tiles in the multiple visual tiles as a user answers questions associated with the multiple visual tiles, until an end condition of the market research survey is satisfied.

In general, in one aspect, a graphical user interface (GUI) includes: multiple visual tiles arranged in a grid formation. The GUI is configured to perform operations including: detecting a user selection of a visual tile in the multiple visual tiles; and presenting a market research survey question from multiple market research survey questions in response to the user selection of the visual tile.

The GUI may be further configured to perform operations including: presenting animations as a user answers questions associated with the multiple visual tiles. The GUI may be further configured to perform operations including: presenting an animation in the GUI indicating completion of the game objective, the game objective including one or more of (a) answering market research survey questions for an entire row of visual tiles in the grid or (b) answering market research survey questions for an entire column of visual tiles in the grid. The GUI may be further configured to perform operations including: replacing visual tiles in the multiple visual tiles as a user answers questions associated with the multiple visual tiles, until an end condition of the market research survey is satisfied.

The GUI may be further configured to perform operations including: in response to a user answering the first market research survey question, presenting an animation in the GUI that replaces the first visual tile with a second visual tile. The GUI may be further configured to perform operations including: in response to a user answering market research survey questions for a first row of visual tiles in the grid, presenting an animation in the GUI that replaces the first row of visual tiles with a second row of visual tiles. The GUI may be further configured to perform operations including: detecting completion of a game objective associated with the market research survey, the game objective including one or more of (a) answering market research survey questions for an entire row of visual tiles in the grid or (b) answering market research survey questions for an entire column of visual tiles in the grid; and presenting an animation in the GUI indicating completion of the game objective. The GUI may be further configured to perform operations including: associating one or more hidden bonuses with a subset of the multiple visual tiles, according to an intermittent reinforcement schedule. The GUI may be further configured to perform operations including: storing data indicating a binding of the first visual tile to the market research survey question; detecting a user command to proceed with the market research survey without answering the first market research survey question; and in response to a subsequent user selection of the first visual tile, again presenting the first market research survey question. The GUI may be further configured to perform operations including: based at least on content of a user response to the first market research survey question, assigning a second market research survey question from the multiple market research survey questions to a second visual tile in the multiple visual tiles. The GUI may be further configured to perform operations including: replacing visual tiles in the multiple visual tiles as a user answers questions associated with the multiple visual tiles, until an end condition of the market research survey is satisfied.

One or more embodiments described in this Specification and/or recited in the claims may not be included in this General Overview section.

### BRIEF DESCRIPTION OF THE DRAWINGS

Various aspects of at least one embodiment are discussed below with reference to the accompanying Figures, which are not intended to be drawn to scale. The Figures are included to provide illustration and a further understanding of the various aspects and embodiments, and are incorporated in and constitute a part of this specification, but are not intended to define the limits of the disclosure. In the Figures, each identical or nearly identical component that is illustrated in various Figures is represented by a like numeral. For the purposes of clarity, some components may not be labeled in every figure. In the Figures:

FIG. 1 is a block diagram of an example of a system according to an embodiment;

FIGS. 2A-2B display a flow diagram of an example of operations for generating and presenting a market research survey interface according to an embodiment;

FIGS. 3A-3R illustrate examples of a gamified market research survey interface according to an embodiment;

FIGS. 4A-4C illustrate examples of animation and visual cues for a gamified market research survey interface according to an embodiment;

FIGS. 5A-5F illustrate examples of a repeatable success animation system for a gamified market research survey interface according to an embodiment;

FIGS. 6A-6H illustrate examples of an application user interaction flow for a gamified market research survey interface according to an embodiment; and

FIG. 7 is a block diagram of an example of a computer system according to an embodiment.

### DETAILED DESCRIPTION

### 1. System Architecture

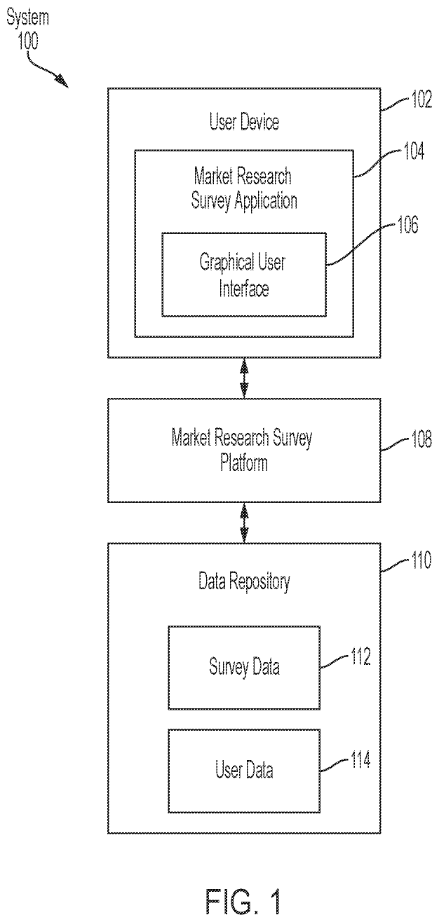

FIG. 1 is a block diagram of an example of a system 100 according to an embodiment. In an embodiment, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

As illustrated in FIG. 1, the system 100 includes a market research survey platform 108, or simply “platform” for ease of discussion, and a user device 102. The user device 102 includes a market research survey application 104, or simply “application” for ease of discussion, configured to communicate with the platform 108 over a network. In response to a user launching the application 104, the application 104 presents a graphical user interface (GUI) 106 on the user device 102. The GUI 106 includes user interface elements for participating in one or more market research surveys. The application 104 is configured to obtain data for populating the GUI 106 from the platform 108, and to communicate results of survey questions to the platform 108.

Together, the platform 108 and application 104 are configured to perform operations described herein for generating and presenting a gamified market research survey interface in the GUI 106. Operations may be allocated between the platform 108 and application 104 in various ways. For example, the application 104 may be a web application accessible via a web browser, and the platform 108 may include a server configured to perform back-end operations to generate content (e.g., survey questions, animations, rewards, and/or other kinds of content as described herein) and provide the content in hypertext markup language (HTML) and/or another web protocol to the GUI 106. Alternatively, the user device 102 may be a device such as smartphone, tablet, laptop, or desktop computer and the application 104 may be an installable application or “app.” The platform 108 may be configured to communicate with two or more kinds of application 104. For example, the platform 108 may include both (a) a web server providing a web-based version of the GUI 106 and (b) an application programming interface (API) accessible by an installable app that includes the GUI 106, thus providing a range of modalities for accessing a market research survey.

In general, the GUI 106 renders user interface elements and receives input via user interface elements. Examples of user interface elements include checkboxes, radio buttons, dropdown lists, list boxes, buttons, toggles, text fields, date and time selectors, command lines, sliders, pages, and forms. In an embodiment, the GUI 106 includes a grid of visual tiles that represent questions in a market research survey, as described herein. The user interface elements allow a user to interact with the market research survey as described herein.

Different components of the GUI 106 may be specified in different languages. The behavior of user interface elements may be specified in a dynamic programming language, such as JavaScript. The content of user interface elements may be specified in a markup language, such as hypertext markup language (HTML), Extensible Markup Language (XML), or XML User Interface Language (XUL). The layout of user interface elements may be specified in a style sheet language, such as Cascading Style Sheets (CSS). Alternatively or additionally, aspects of a GUI 106 may be specified in one or more other languages, such as Java, Python, Perl, C, C++, C#, and/or any other language or combination thereof.

As illustrated in FIG. 1, a data repository 110 may be configured to store survey data 112. Survey data 112 includes data associated with one or more surveys, such as: survey questions; answer options; game rewards associated with survey questions; and/or other survey-related data. Alternatively or additionally, a data repository 110 may be configured to store user data 114. User data 114 includes data associated with one or more users, such as: user profile information; login credentials; survey answers (which may be anonymized and/or aggregated among users); game rewards earned by each user; and/or other user-related data.

In an embodiment, a data repository 110 is any type of storage unit and/or device (e.g., a file system, database, collection of tables, or any other storage mechanism) for storing data. A data repository 110 may include multiple different storage units and/or devices. The multiple different storage units and/or devices may or may not be of the same type or located at the same physical site. Further, a data repository 110 may be implemented or may execute on the same computing system as one or more other components of the system 100. Alternatively or additionally, a data repository 110 may be implemented or executed on a computing system separate from one or more other components of the system 100. A data repository 110 may be logically integrated with one or more other components of the system 100. Alternatively or additionally, a data repository 110 may be communicatively coupled to one or more other components of the system 100 via a direct connection or via a network. In FIG. 1, a data repository 110 is illustrated as storing various kinds of information. Some or all of this information may be implemented and/or distributed across any of the components of the system 100. However, this information is illustrated within the data repository 110 for purposes of clarity and explanation.

In an embodiment, one or more components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 2. Grid Interface and Gamification

As described herein, one or more embodiments are configured to generate and present a GUI that includes a grid of visual tiles corresponding to survey questions. A GUI as described herein may include one or more of the following aspects and features:

A. Familiarity. A grid configuration will likely be reminiscent to consumers from contexts in the physical realm, apart from the realm of digital market research surveys and interactive media in general. For example, grid layouts can be found in telephone number pads, calculators, automated teller machine (ATM) number pads, the pen-and-paper games of Sudoku and tic-tac-toe, and other physical items that consumers are familiar with. Providing a user interface with a reminiscent visual structure may help reduce the user's cognitive load. A user may be naturally drawn to interact with a grid interface in a way that other layouts do not promote.

B. Game-like appearance and experience. Aside from being reminiscent of familiar physical items from other contexts, one or more embodiments of the GUI provide a game-like appearance and experience. For example, tiles may be logically stacked on each other (i.e., from bottom to top of the screen), so that when a row of tiles is completed, another row may fall down from “above.” Alternatively, when an individual tile is completed, it may be “cleared” and tiles may fall down from above to occupy the vacant space. In other embodiments, rows, columns, and/or individual tiles may be cleared and replaced in various other ways. Some examples of animations and other game-like aspects, according to one or more embodiments, are described in further detail herein.

C. Repeatable success animation system. In an embodiment, repeatable success animations are visual animations that occur in response to a user completing a task or set of tasks (also referred to herein as “game objectives”). For example, a repeatable success animation may occur when a tile, row of tiles, and/or column of tiles is completed, i.e., when the answer(s) associated with the tile(s) is/are completed. For example, one or more tiles may “drop off” the screen as described herein. Alternatively or additionally, a completed tile, row, and/or column may visually “explode” or otherwise react when a question or set of questions is completed. Such animations may increase user engagement with the survey process, thus increasing the likelihood of the user completing questions. That is, a user may be drawn to clear tiles by virtue of the visual features of the user interface that contribute to a game-like experience.

D. Gamification. In general, gamification includes game-like features that encourage the completion of tasks. One or more embodiments may be gamified in various ways. As described herein, tiles may be designed to provide a game-like interface and experience (e.g., through dropping tiles, explosions, etc.). As another example, different styles (e.g., colors, patterns, images, animations, etc.) may be applied to different tiles, to help drive user engagement. Tile styles may be user-configurable or determined by the system. The system may set tile styles to coincide with holidays, other special events, time of day, and/or general seasonal themes (e.g., by comparing the system date and/or time with an internal mapping of styles to dates and/or times).

The questions associated with each tile may not be visible until a user selects a tile, thus providing an element of mystery or surprise. The hidden nature of the questions may also allow the underlying system to dynamically determine which content/questions to serve to a user (based, for example, on a predefined cohort analysis and/or other factors). When selected, tiles may provide a bonus such as extra points, point multipliers, badges, special incentives, and/or other kinds of bonuses. Bonuses may be provided based on predetermined, predictable criteria (e.g., according to a fixed schedule or completion of specific game objectives) and/or according to a randomized intermittent reinforcement schedule that is behaviorally associated with increased engagement. Accordingly, in some examples described herein, the programming of tiles may be expected to produce a “dopamine rush” (e.g., because the user does not know in advance what is “behind” each tile).

E. Reduced Bias. In some embodiments described herein, because the user does not know what is “behind” each tile, the user is unable to select the questions that they prefer to answer. The system can therefore present questions to the user in an unbiased manner that the user cannot directly influence. Questions served up to the user may be determined based on demographic and/or profile attributes, responses to previously-asked questions, weighting related to specific opportunities, the collection or refreshing of profile information, and/or based on one or more other factors designed to drive user engagement and interest.

In some embodiments described herein, in response to a user selecting a tile, the system is configured to present the highest-priority question, based for example on weight and/or time. If a user “closes” the tile, the tile remains associated with (or “bound to”) that question until the question is answered, expires, or is “skipped” by the user. In response to the user clicking/selecting another tile, the system is configured to present the next question available (e.g., according to the same priority scheme), as long as the tile is not already bound to a question from having been previously selected. In response to the user answering a question, the system may recompute some or all of the grid (e.g., all tiles that are not already bound to questions). The questions mapped to the unbound tiles may be reloaded “in the background,” i.e., without the user knowing that the questions associated with tiles have changed. In this manner, the user's answer to one question may trigger the system to serve up a higher-priority retargeting question for the next tile that is selected, unless that tile has already been bound to another question.

### 3. Interaction Triggers

One or more embodiments described herein leverage the concept of interaction triggers. Interaction triggers refer to the mechanics, behavior, reinforcement schedules, and rewards that help form the user's experience of the application.

A. Mechanics. One or more embodiments described herein leverage mental models with a familiar design concept (e.g., a grid layout as described herein, and/or another kind of layout). A game-like interface taps into gamification strategies. Questions that are hidden “beneath” tiles until selected may help reduce the bias in question selection that is seen in traditional market research platforms (i.e., users selecting questions according to their own preferences, which can provide an unhelpfully narrow set of answers relative to the body of information sought by market researchers). Some examples may include options for personalized content, tile-design, animations, and/or other features (e.g., based on user-specified application settings), thus further increasing user engagement with the process.

B. Behavior. One or more embodiments described herein use application mechanics (e.g., one or more mechanics described herein) that are designed to encourage users to clear more tiles. Such mechanics may provide a sense of accomplishment for clearing tiles. In some examples, one or more mechanics is/are designed to trigger a dopamine rush effect, such as when a user does not initially know what is behind a selected tile (e.g., a bonus, such as bonus points, may be hidden “beneath” a tile), before selecting/tapping the tile.

C. Reinforcement Schedules. One or more embodiments described herein use a grid that has a number of tiles designed to provide the user with a routine reinforcement schedule, leading to a sense of accomplishment with enough frequency to encourage ongoing participation. For example, a 3×3 grid of 9 total tiles may allow the user to have a sense of a manageable “set” of questions that can be completed. This format can help the user develop an easily repeatable pattern into a habit. For example, the pattern could be expressed as “Tap a tile, explode a tile, clear all tiles,” or another repeatable pattern of behavior that allows the user to continue feeling a sense of accomplishment. In some embodiments described herein, the system continues to deliver N total tiles, where N is the total size of the grid, unless there are no longer that many questions available to answer. If there are fewer questions available, then the system may fill in whatever is available. Alternatively or additionally, bonuses may be provided based on a randomized intermittent reinforcement schedule that is behaviorally associated with increased engagement.

D. Rewards. One or more embodiments described herein include user interface elements (e.g., a repeatable success animation system and/or other visual elements) that increase the user reward experience within a game-like visual design. The tile design and behavior may be designed to allow users to feel a continuous sense of reward. Thus, while points, gift cards, and/or other quantifiable rewards may be included, the sense of accomplishment for clearing tiles and/or sets of tiles may be rewarding as well.

### 4. Operations for Generating and Presenting a Gamified Market Research Survey Interface

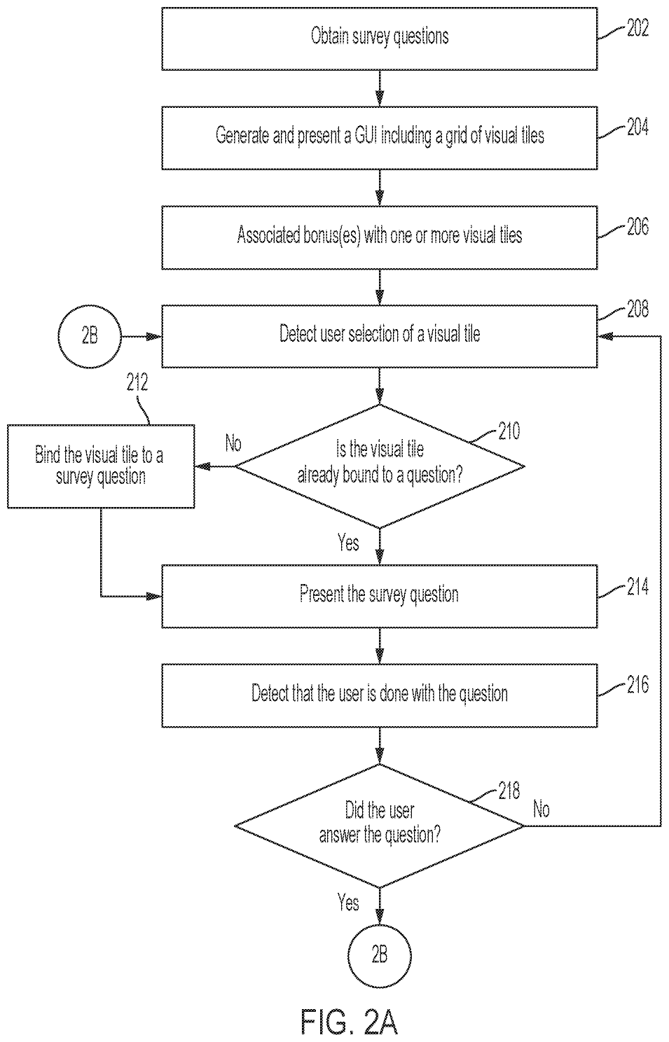

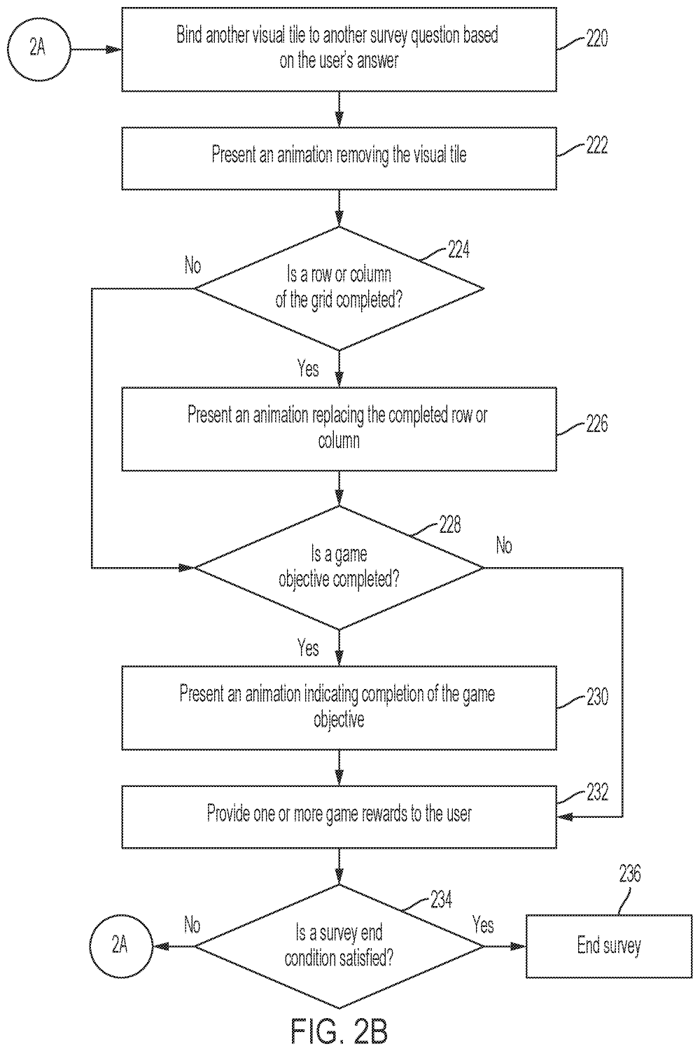

FIGS. 2A-2B display a flow diagram of an example of operations for generating and presenting a gamified market research survey interface according to an embodiment. One or more operations illustrated in FIGS. 2A-2B may be modified, rearranged, or omitted all together. Accordingly, the particular sequence of operations illustrated in FIGS. 2A-2B should not be construed as limiting the scope of one or more embodiments.

Operations described below may be performed by one or more components of a system, such as the system illustrated in FIG. 1. Specifically, one or more operations may be performed by a market research survey platform, and one or more operations may be performed by a market research survey application. The allocation of operations between the platform and application may vary from one implementation to another, depending for example on the kind of application (e.g., a web-based application versus an installable application) used. For ease of discussion, the component(s) performing each operation are referred to below as the “system.”

In an embodiment, the system obtains survey questions (Operation 202). The system generates and presents a GUI, including a grid of visual tiles (Operation 204). Each tile in the grid represents a survey question. As described herein, the size of the grid may be designed to increase user engagement by providing a sense of accomplishment for “completing” the grid, without being overwhelming. The grid may be an N×N grid in which rows and columns have the same number of tiles (e.g., 3×3). Alternatively, rows and columns may have different numbers of tiles (e.g., 3×4). The numbers of rows and tiles may be adjustable and/or user-configurable.

The appearance of tiles in the grid may be user-customizable. For example, a user may be able to select from a gallery of available tile “backs” or designs. Alternatively or additionally, the appearance of tiles may depend on the date and/or time. For example, the system may compare the current date with a holiday schedule. If the current date is associated with a holiday, the system may select an appearance for the tiles corresponding to that holiday. For example, on Valentine's Day, the system may select a tile design that includes hearts, cupids, and/or other visual features associated with Valentine's Day. As another example, the system may obtain the local time and adjust the appearance of tiles based on the time, e.g., using a design that includes moons if it is currently after dusk. The system may adjust the appearance of tiles based on weather data, location data, date, time, and/or other factors. Alternatively or additionally, the tile design may be user-customizable.

In an embodiment, survey questions are not initially visible in the grid, but are hidden “beneath” the tiles and revealed in the GUI as a user selects tiles. Specific tiles may not initially be bound to specific survey question. That is, the hidden nature of the questions in the grid may be designed to provide a false sense of randomness in the questions revealed, when in fact the order of questions presented to a user may not depend on the specific tile selected. Alternatively or additionally, one or more of the tiles may be pre-bound to a specific question. Binding questions to tiles as they are selected may give the impression to the user that tiles are pre-bound to specific questions.

The system may associate one or more bonuses with one or more of the tiles (Operation 206). A bonus may take the form of a special animation, a game reward (e.g., points, coins, and/or some other kind of quantifiable reward), and/or some other kind of bonus that is not normally provided when a user selects a tile. As described herein, rewards may be redeemable. A tile at a specific location in the grid may be associated with a bonus, so that the bonus is revealed in response to a user selecting that tile. For example, a bonus may be associated with the topmost, rightmost tile, regardless of what question is provided when a user selects that tile. Alternatively or additionally, bonuses may be revealed according to an intermittent reinforcement schedule, regardless of the specific locations of tiles selected. An intermittent reinforcement schedule for providing bonuses may help increase user engagement with the market research survey, by tapping into dopamine responses that are enhanced by intermittent reinforcement.

After presenting the grid, the system detects user selection of a visual tile (Operation 208). For example, if the user device has a touchscreen, the system may detect a tap at the location of a tile. Alternatively, the system may detect a mouse click, keypress, voice command, or other kind of user input to select a particular tile.

As noted above, specific tiles may not be bound initially to specific questions. In response to a user selecting a tile, the system may determine whether the tile is already bound to a question (Decision 210). If the tile is not already bound to a question, then the system may bind the tile to a specific question (Operation 212). For example, if the system is configured to present questions in a specific sequence, the system may bind the next question in the sequence to the selected tile.

After a user selects a tile, the system presents a survey question (Operation 214). As described in further detail herein, the system may use an animation to present the survey question, thus contributing to gamification of the interface. The survey question may take many different forms. For example, the survey question may be a multiple-choice question, an open-ended question, a fill-in-the-blanks question, a yes/no question, or another kind of question.

In an embodiment, the system detects that the user is done with the question that was presented (Operation 216). The system may require the user to answer the presented question before proceeding. Alternatively, the system may allow a user to dismiss or “close” a question without answering it. How the system proceeds may depend on whether the user answered the question (Decision 218). If a user dismisses a question without answering it, the selected tile may remain bound to that question, so that if the user selects the same tile again, the same question is presented. As noted above, binding tiles to questions as the tiles are selected may help give the impression that the locations of questions in the grid are predetermined before the tiles are selected. In addition, binding a tile to a question may require a user to answer that question before achieving any game objectives that require “clearing” that specific tile (e.g., completing a row or column that includes that tile).

If the user answers the question, the system may bind another tile to another survey question, based on the user's answer (Operation 220). For example, survey questions may be stored in a decision tree, where the specific question and order thereof depends on previous answers. The system may access the decision tree to determine which survey question should be presented to the user next. Alternatively, the system may not bind another tile to another question until the user selects another tile. Some examples of criteria for determining which question to present next are described herein.

In response to a user answering a question, the system may present an animation removing the visual tile that was associated with that question (Operation 222). The animation may include the visual tile exploding, fading away, decreasing in size to nothing, sliding off-screen, or otherwise disappearing. The space occupied by the removed tile may be left blank or may include a visual representation of a game reward (e.g., a certain number of game “points” or “coins”) earned by answering the question. Alternatively, the space may be occupied by another tile. For example, tiles may “drop down” from the top of the screen to occupy empty spots below. If a space at the top of the screen is cleared, a new tile may “drop down” from off-screen to occupy that space. Alternatively, a tile may expand from nothing to occupy the space, slide in from off-screen, or otherwise appear to occupy the vacant space.

The system may present an animation when two or more tiles have been cleared in a specific pattern. For example, the system may determine whether a row or column of tiles in the grid has been cleared (Decision 224). If a row or column of tiles has been cleared (or another predetermined pattern of tiles), the system may present an animation replacing the completed tiles (Operation 226). The animation may include tiles “dropping down” to occupy the vacant spaces left by the completed tiles (e.g., dropping down to occupy a vacant row or column), expanding from nothing to occupy the space, sliding in from off-screen, or otherwise appearing to occupy the space left by the completed tiles.

As described herein, gamification may include game objectives that produce special results upon completion. A game objective may include clearing a row of tiles, clearing a column of tiles, clearing a certain number of tiles (i.e., answering a certain number of questions), clearing an entire screen of tiles, completing an entire market research survey, completing a certain number of market research surveys, and/or another kind of objective associated with the user's performance in one or more market research surveys. In response to a user answering a question, the system may determine whether a game objective was completed (Decision 228). If a game objective was completed, the system may present an animation indicating completion of the game objective. For example, if the game objective included completing a row or column, then the animation may include replacing the row or column as described above.

As the user answers questions (e.g., upon answering each question and/or upon completing game objectives), the system may provide one or more game rewards to the user (Operation 232). Game rewards may include “points,” “coins,” and/or another form of in-game currency that is redeemable by the user. For example, a user may be able to redeem rewards to change the visual style of tiles, receive a product or discount from a company (e.g., the company for whom the survey is being conducted), unlock a previously inaccessible feature of the application (e.g., minigames, new surveys, etc.), unlock previously unavailable user avatar customizations, and/or other receive another kind of benefits for which the rewards may be redeemed.

In an embodiment, the system determines whether a survey end condition is satisfied (Decision 234). A survey end condition may be that there are no more questions to be answered (e.g., based on the available questions and/or a determination that no further answers are desired from this particular user), that a certain number of questions has been answered, and/or another kind of end condition. A given survey may have multiple possible end conditions. If an end condition is not satisfied, then the user may be allowed to continue answering questions until an end condition is satisfied. Once the end condition is satisfied, the survey ends (Operation 236). As noted above, ending the survey may include an animation presenting indicating completion of a game objective and/or providing a game reward to the user.

### 5. Detailed Examples

Detailed examples are described below for purposes of clarity. Components and/or operations described below should be understood as examples that may not be applicable to one or more embodiments. Accordingly, components and/or operations described below should not be construed as limiting the scope of one or more embodiments.

In the figures accompanying the following examples, a market research survey is being completed in a smartphone application, according to one or more embodiments described herein. Similar concepts may be applied to other interfaces (e.g., a tablet, laptop, desktop, game console, etc.) with appropriate modifications to accommodate the different screen and input formats provided by each platform.

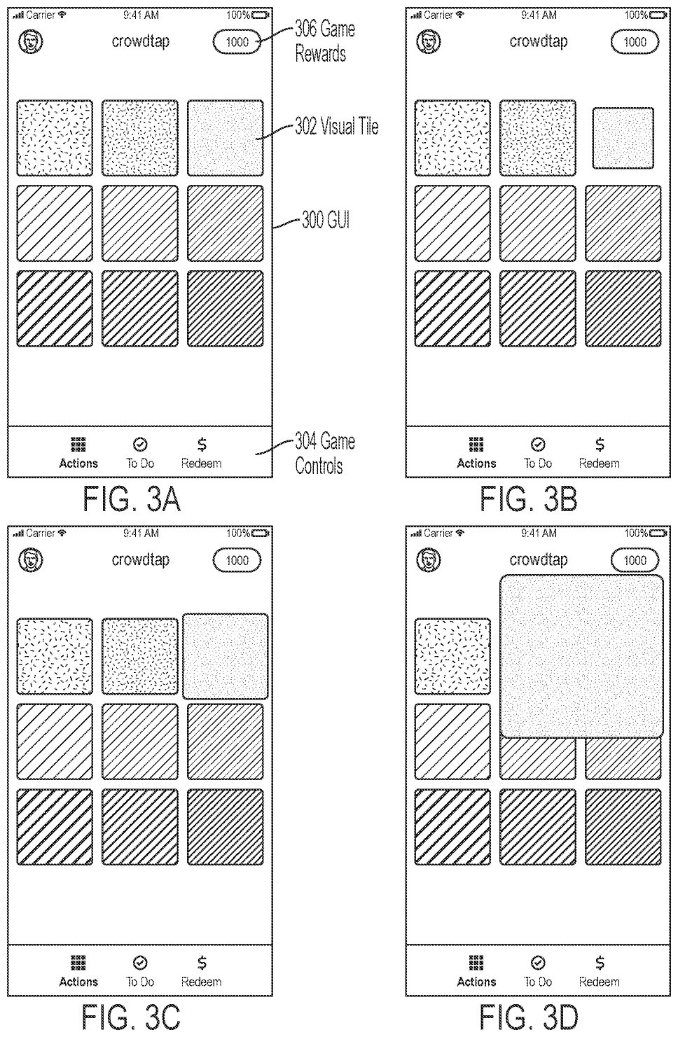

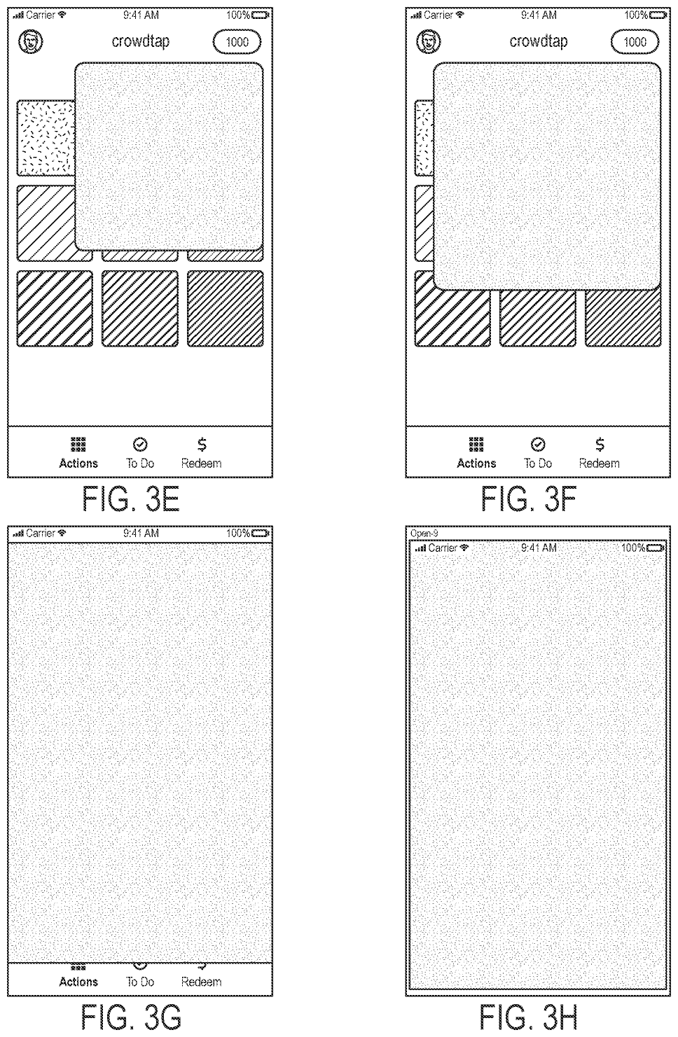

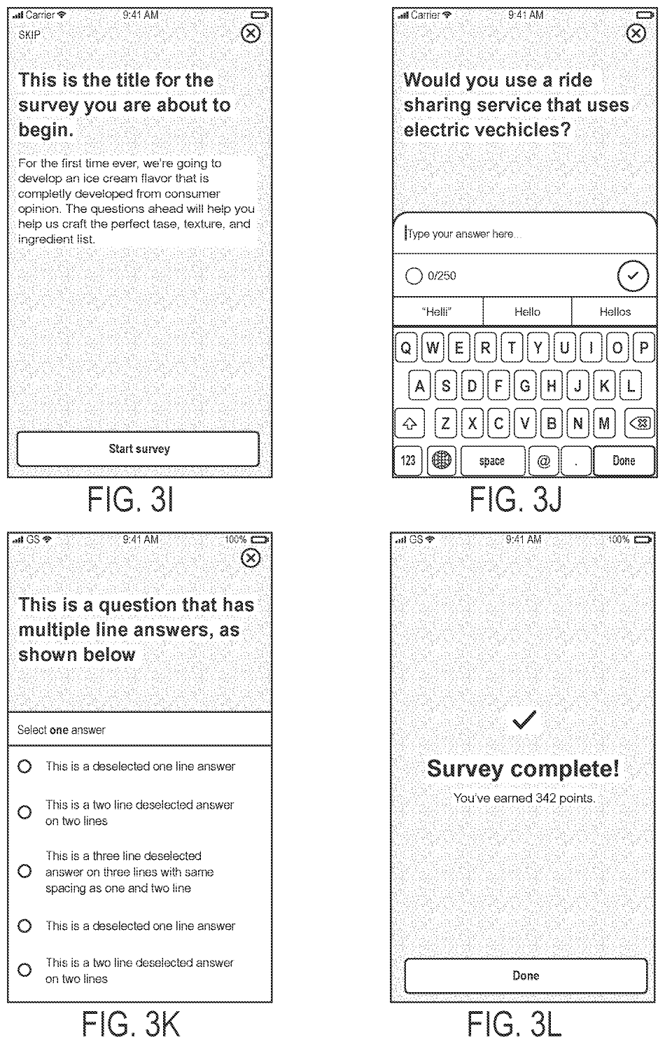

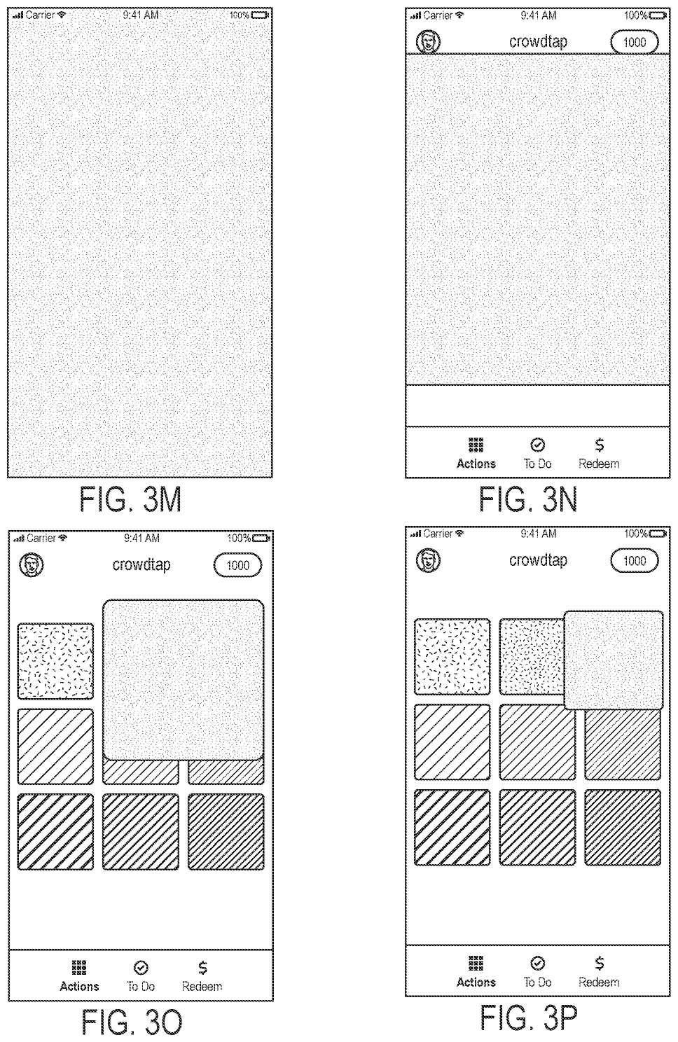

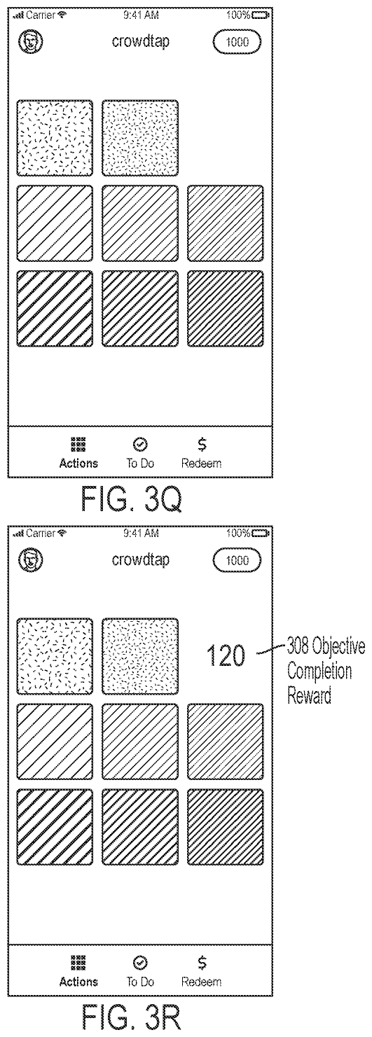

FIGS. 3A-3P illustrate examples of a gamified market research survey interface according to an embodiment. As illustrated in FIGS. 3A-3P, a graphical user interface (GUI) 300 includes multiple visual tiles 302. The GUI further indicates a current state of game rewards 306, and provides a set of game controls 304 (e.g., access to various actions available in the application, a set of tasks or game objectives to be completed, an option to redeem the game rewards 306, and/or other functionality of the application).

In the example illustrated in FIGS. 3A-3P, a user selects the tile at the top right of the grid. FIGS. 3B-3H illustrate an example of an animation, presented in response to the user selection, that expands or “turns over” the tile, culminating in revealing the survey question. FIGS. 3I-3K illustrate some non-limiting examples of question interfaces. In FIG. 3I, a survey includes introductory text that explains the purpose of the survey questions and primes the user to answer them in a helpful manner. FIG. 3J illustrates an example of an open-ended question, where the user is able to enter free-form text (in this example, up to 250 characters). FIG. 3K illustrates placeholder text for a multiple-choice question. FIG. 3L illustrates an example of a screen that may be presented upon completing a survey (which may include multiple questions), with rewards being awarded upon a user completing a survey.

FIGS. 3M-3Q illustrate an example of an animation that may be presented upon completing a question, transitioning back to the grid and revealing an empty space at the location of the selected tile. FIG. 3R illustrates an example in which the empty space is populated with an objective completion reward 308, in this case a certain number of points that is added to the total rewards (not shown in this example).

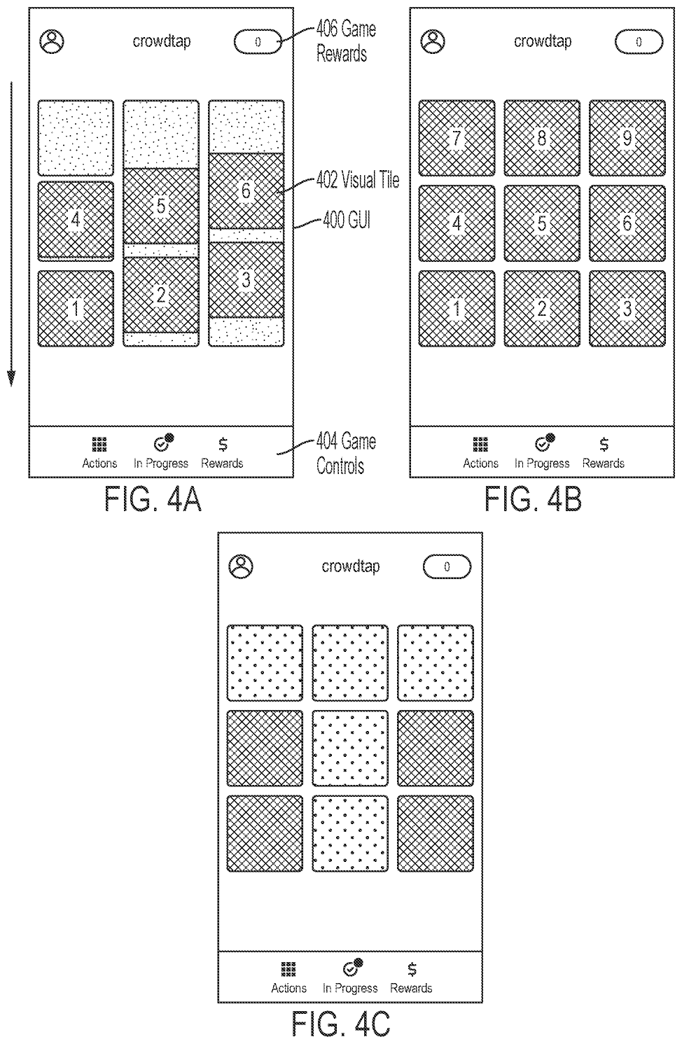

FIGS. 4A-4C illustrate examples of animation and visual cues for a gamified market research survey interface according to an embodiment. As illustrated in FIGS. 4A-4C, a graphical user interface (GUI) 400 includes multiple visual tiles 402. The GUI further indicates a current state of game rewards 406, and provides a set of game controls 404 (e.g., access to various actions available in the application, a set of tasks or game objectives to be completed, an option to redeem the game rewards 406, and/or other functionality of the application).

Specifically, FIG. 4A illustrates an example of tiles “dropping” off the screen, in the order indicated by the numbers in each tile. In FIG. 4B, the numbers in each tile indicate the order in which tiles may drop off the board generally, in an embodiment. FIG. 4C illustrates an example of different tiles having different visual styles, to help make the GUI 400 more interesting and increase user engagement. Animations such as tiles “dropping off” may help promote the gamified idea of the user clearing the entire board.

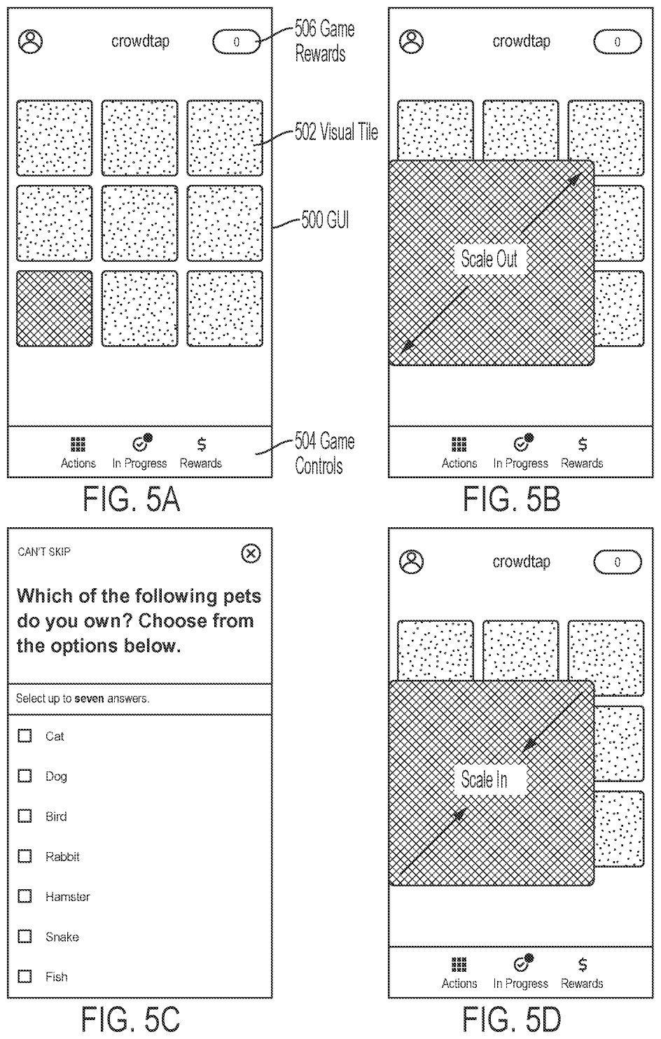

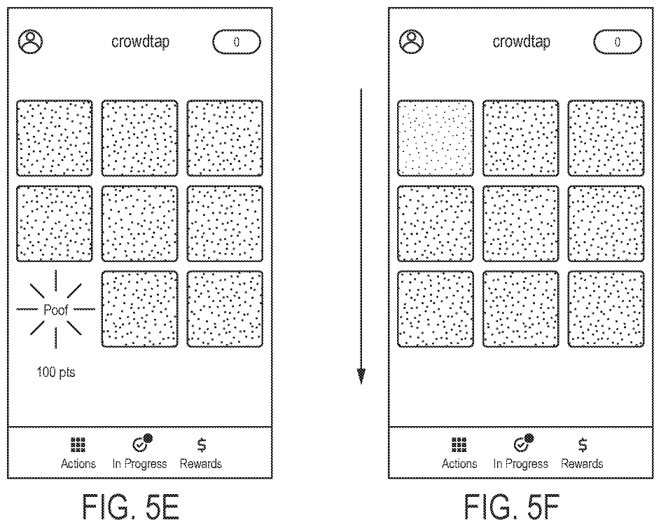

FIGS. 5A-5F illustrate examples of a repeatable success animation system for a gamified market research survey interface according to an embodiment. As illustrated in FIGS. 5A-5F, a graphical user interface (GUI) 500 includes multiple visual tiles 502. The GUI further indicates a current state of game rewards 506, and provides a set of game controls 504 (e.g., access to various actions available in the application, a set of tasks or game objectives to be completed, an option to redeem the game rewards 506, and/or other functionality of the application).

Specifically, FIG. 5A illustrates an example of changing the visual appearance of a tile that is selected. FIG. 5B illustrates an example of expanding or “scaling out” the selected tile. FIG. 5C illustrates an example of presenting a survey question after selecting a tile, upon completion of any associated animation. FIG. 5D illustrates an example of contracting or “scaling in” the tile upon completion of the question. FIG. 5E illustrates an example of an “explosion” animation that clears the tile in response to the question being answered. FIG. 5F illustrates an example of tiles dropping down to occupy the newly vacant space in the grid. In an embodiment, repeated animations such as those described herein help promote user engagement with the tiles and communicate success in both the selection and subsequent response to the questions that the system provides.

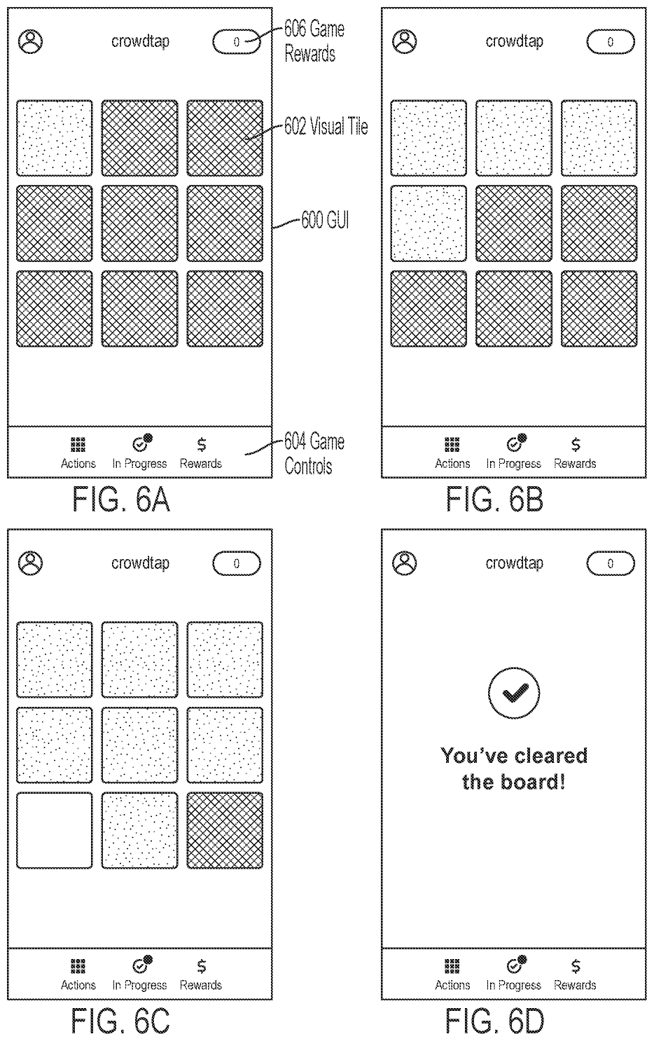

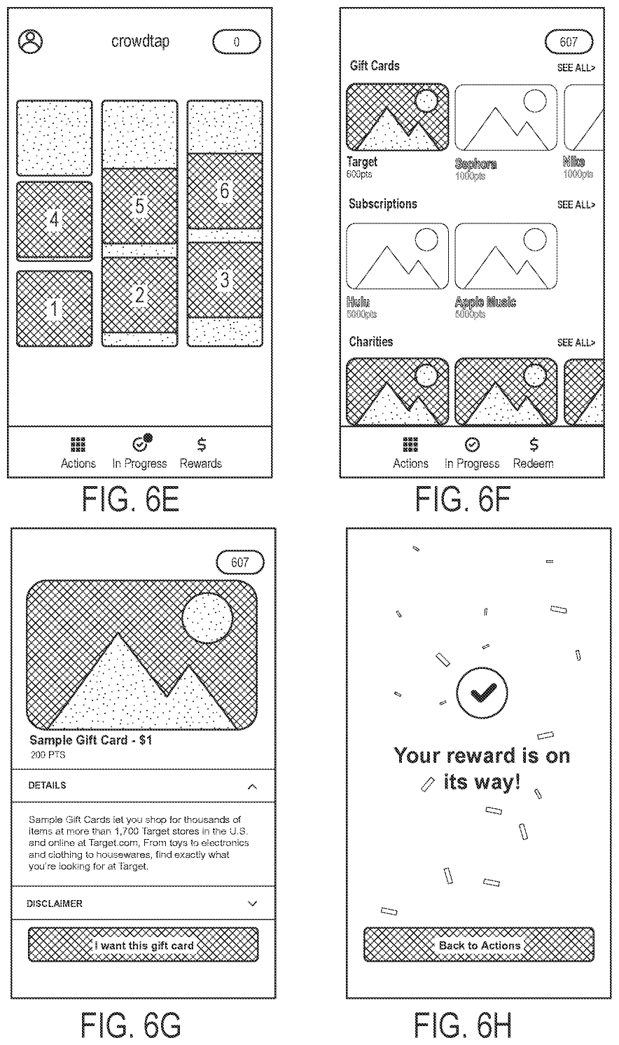

FIGS. 6A-6H illustrate examples of an application user interaction flow for a gamified market research survey interface according to an embodiment. As demonstrated by these examples, the end-to-end user flow for each question may be a consistent experience with expected and repeatable interactions. However, the mystery of what lies “beneath” each tile may provide a sense of surprise and delight to the user. This approach may help keep users engaged by the interface, while encouraging authentic and unbiased responses when a new and unexpected survey question is provided.

As illustrated in FIGS. 6A-6H, a graphical user interface (GUI) 600 includes multiple visual tiles 602. The GUI further indicates a current state of game rewards 606, and provides a set of game controls 604 (e.g., access to various actions available in the application, a set of tasks or game objectives to be completed, an option to redeem the game rewards 606, and/or other functionality of the application).

Specifically, FIG. 6A illustrates an example of a single “cleared” tile, the left topmost tile. In FIG. 6B, four tiles have been cleared. In FIG. 6C, eight of the nine tiles have been cleared. In FIG. 6D, all of the tiles have been cleared and the system presents a success animation. FIG. 6E illustrates an example of tiles illustrates an example of tiles “dropping” off the screen, in the order indicated by the numbers in each tile. FIG. 6F illustrates an example of an interface for redeeming game rewards 606. In this example, game rewards 606 may be redeemed for gift cards, subscriptions, or charitable donations. Each option has an associated point value, so that greater success in accumulating the game rewards 606 results in correspondingly more valuable redemption options. FIG. 6G illustrates an example of details associated with a particular redemption option, in this case a gift card valued at $1 U.S. and costing 200 points. As illustrate in FIG. 6H, when a user redeems game rewards 606, the system may present a screen with visual elements (in this example, illustrations of confetti) that help provide a sense of accomplishment.

### 6. Miscellanous; Computer Systems; Networks

In an embodiment, a system includes one or more devices, including one or more hardware processors, that are configured to perform any of the operations described herein and/or recited in any of the claims.

In an embodiment, one or more non-transitory computer-readable storage media store instructions that, when executed by one or more hardware processors, cause performance of any of the operations described herein and/or recited in any of the claims.

Any combination of the features and functionalities described herein may be used in accordance with an embodiment. In the foregoing specification, embodiments have been described with reference to numerous specific details that may vary from implementation to implementation. Accordingly, the specification and figures are to be regarded in an illustrative rather than a restrictive sense. The sole and exclusive indicator of the scope of the invention, and what is intended by the Applicant to be the scope of the invention, is the literal and equivalent scope of the set of claims that issue from this application, in the specific form in which such claims issue, including any subsequent correction.

In an embodiment, techniques described herein are implemented by one or more special-purpose computing devices (i.e., computing devices specially configured to perform certain functionality). The special-purpose computing device(s) may be hard-wired to perform the techniques and/or may include digital electronic devices such as one or more application-specific integrated circuits (ASICs), field programmable gate arrays (FPGAs), and/or network processing units (NPUs) that are persistently programmed to perform the techniques. Alternatively or additionally, a computing device may include one or more general-purpose hardware processors programmed to perform the techniques pursuant to program instructions in firmware, memory, and/or other storage. Alternatively or additionally, a special-purpose computing device may combine custom hard-wired logic, ASICs, FPGAs, or NPUs with custom programming to accomplish the techniques. A special-purpose computing device may include a desktop computer system, portable computer system, handheld device, networking device, and/or any other device(s) incorporating hard-wired and/or program logic to implement the techniques.

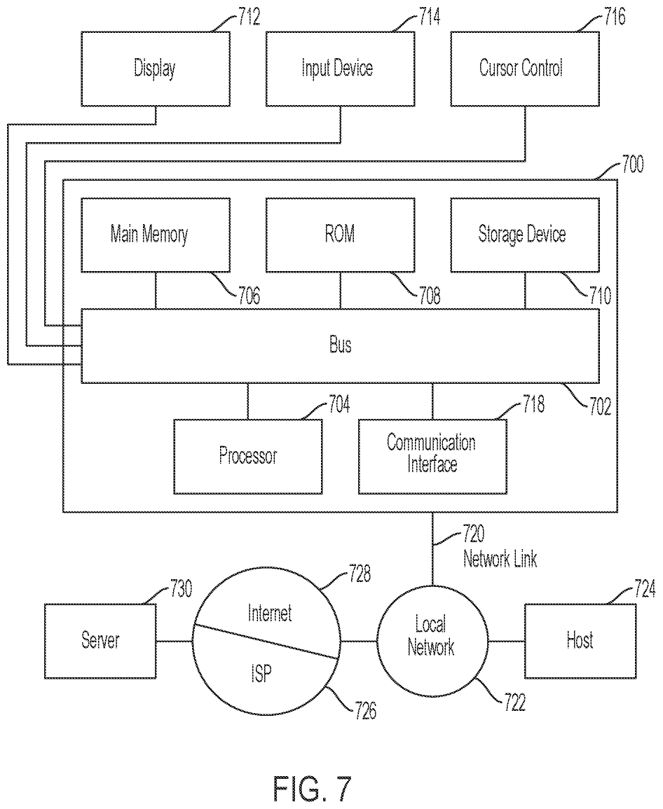

For example, FIG. 7 is a block diagram of an example of a computer system 700 according to an embodiment. Computer system 700 includes a bus 702 or other communication mechanism for communicating information, and a hardware processor 704 coupled with the bus 702 for processing information. Hardware processor 704 may be a general-purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in one or more non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a liquid crystal display (LCD), plasma display, electronic ink display, cathode ray tube (CRT) monitor, or any other kind of device for displaying information to a computer user. An input device 714, including alphanumeric and other keys, may be coupled to bus 702 for communicating information and command selections to processor 704. Alternatively or additionally, computer system 700 may receive user input via a cursor control 716, such as a mouse, a trackball, a trackpad, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. Alternatively or additionally, computer system 7 may include a touchscreen. Display 712 may be configured to receive user input via one or more pressure-sensitive sensors, multi-touch sensors, and/or gesture sensors. Alternatively or additionally, computer system 700 may receive user input via a microphone, video camera, and/or some other kind of user input device (not shown).

Computer system 700 may implement the techniques described herein using customized hard-wired logic, one or more ASICs or FPGAs, firmware, and/or program logic which in combination with other components of computer system 700 causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. Alternatively or additionally, hard-wired circuitry may be used in place of or in combination with software instructions.

The term “storage media” as used herein refers to one or more non-transitory media storing data and/or instructions that cause a machine to operate in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape or other magnetic data storage medium, a CD-ROM or any other optical data storage medium, any physical medium with patterns of holes, a RAM, a programmable read-only memory (PROM), an erasable PROM (EPROM), a FLASH-EPROM, non-volatile random-access memory (NVRAM), any other memory chip or cartridge, content-addressable memory (CAM), and ternary content-addressable memory (TCAM).

A storage medium is distinct from but may be used in conjunction with a transmission medium. Transmission media participate in transferring information between storage media. Examples of transmission media include coaxial cables, copper wire, and fiber optics, including the wires that comprise bus 702. Transmission media may also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer may load the instructions into its dynamic memory and send the instructions over a network, via a network interface controller (NIC), such as an Ethernet controller or Wi-Fi controller. A NIC local to computer system 700 may receive the data from the network and place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722, and communication interface 718.

The received code may be executed by processor 704 as it is received, and/or stored in storage device 710, or other non-volatile storage for later execution.

In an embodiment, a computer network provides connectivity among a set of nodes running software that utilizes techniques as described herein. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (for example, a request to execute a particular application and/or retrieve a particular set of data). A server process responds by executing the requested service and/or returning corresponding data.

A computer network may be a physical network, including physical nodes connected by physical links. A physical node is any digital device. A physical node may be a function-specific hardware device. Examples of function-specific hardware devices include a hardware switch, a hardware router, a hardware firewall, and a hardware NAT. Alternatively or additionally, a physical node may be any physical resource that provides compute power to perform a task, such as one that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (for example, a physical network). Each node in an overlay network corresponds to a respective node in the underlying network. Accordingly, each node in an overlay network is associated with both an overlay address (to address the overlay node) and an underlay address (to address the underlay node that implements the overlay node). An overlay node may be a digital device and/or a software process (for example, a virtual machine, an application instance, or a thread). A link that connects overlay nodes may be implemented as a tunnel through the underlying network. The overlay nodes at either end of the tunnel may treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources may be shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, a system supports multiple tenants. A tenant is a corporation, organization, enterprise, business unit, employee, or other entity that accesses a shared computing resource (for example, a computing resource shared in a public cloud). One tenant (through operation, tenant-specific practices, employees, and/or identification to the external world) may be separate from another tenant. The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In an embodiment, in a multi-tenant computer network, tenant isolation is implemented to ensure that the applications and/or data of different tenants are not shared with each other. Various tenant isolation approaches may be used. In an embodiment, each tenant is associated with a tenant ID. Applications implemented by the computer network are tagged with tenant ID's. Additionally or alternatively, data structures and/or datasets, stored by the computer network, are tagged with tenant ID's. A tenant is permitted access to a particular application, data structure, and/or dataset only if the tenant and the particular application, data structure, and/or dataset are associated with a same tenant ID. As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants. A subscription list may indicate which tenants have authorization to access which applications. For each application, a list of tenant ID's of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels may be used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

What is claimed is:

1. One or more non-transitory computer-readable media storing instructions that, when executed by one or more processors, cause the one or more processors to perform operations comprising:
generating a graphical user interface (GUI) for a market research survey, the GUI comprising a grid of a plurality of visual tiles;
detecting a user selection of a first visual tile in the plurality of visual tiles; and
in response to the user selection of the first visual tile, presenting a first market research survey question from a plurality of market research survey questions.

2. The one or more non-transitory computer-readable media of claim 1, the operations further comprising:
in response to a user answering the first market research survey question, presenting an animation in the GUI that replaces the first visual tile with a second visual tile.

3. The one or more non-transitory computer-readable media of claim 1, the operations further comprising:
in response to a user answering market research survey questions for a first row of visual tiles in the grid, presenting an animation in the GUI that replaces the first row of visual tiles with a second row of visual tiles.

4. The one or more non-transitory computer-readable media of claim 1, the operations further comprising:
detecting completion of a game objective associated with the market research survey, the game objective comprising one or more of (a) answering market research survey questions for an entire row of visual tiles in the grid or (b) answering market research survey questions for an entire column of visual tiles in the grid; and
presenting an animation in the GUI indicating completion of the game objective.

5. The one or more non-transitory computer-readable media of claim 1, the operations further comprising:
associating one or more hidden bonuses with a subset of the plurality of visual tiles, according to an intermittent reinforcement schedule.

6. The one or more non-transitory computer-readable media of claim 1, the operations further comprising:
storing data indicating a binding of the first visual tile to the market research survey question;
detecting a user command to proceed with the market research survey without answering the first market research survey question; and
in response to a subsequent user selection of the first visual tile, again presenting the first market research survey question.

7. The one or more non-transitory computer-readable media of claim 1, the operations further comprising:
based at least on content of a user response to the first market research survey question, assigning a second market research survey question from the plurality of market research survey questions to a second visual tile in the plurality of visual tiles.

8. The one or more non-transitory computer-readable media of claim 1, the operations further comprising:
replacing visual tiles in the plurality of visual tiles as a user answers questions associated with the plurality of visual tiles, until an end condition of the market research survey is satisfied.

9. A method comprising:
generating a graphical user interface (GUI) for a market research survey, the GUI comprising a grid of a plurality of visual tiles;
detecting a user selection of a first visual tile in the plurality of visual tiles; and
in response to the user selection of the first visual tile, presenting a first market research survey question from a plurality of market research survey questions.

10. The method of claim 9, further comprising:
in response to a user answering the first market research survey question, presenting an animation in the GUI that replaces the first visual tile with a second visual tile.

11. The method of claim 9, further comprising:
responsive to a user answering market research survey questions for a first row of visual tiles in the grid, presenting an animation in the GUI that replaces the first row of visual tiles with a second row of visual tiles.

12. The method of claim 9, further comprising:
detecting completion of a game objective associated with the market research survey, the game objective comprising one or more of (a) answering market research survey questions for an entire row of visual tiles in the grid or (b) answering market research survey questions for an entire column of visual tiles in the grid; and
presenting an animation in the GUI indicating completion of the game objective.

13. The method of claim 9, further comprising:
associating one or more hidden bonuses with a subset of the plurality of visual tiles, according to an intermittent reinforcement schedule.

14. The method of claim 9, further comprising:
storing data indicating a binding of the first visual tile to the market research survey question;
detecting a user command to proceed with the market research survey without answering the first market research survey question; and
in response to a subsequent user selection of the first visual tile, again presenting the first market research survey question.

15. The method of claim 9, further comprising:
based at least on content of a user response to the first market research survey question, assigning a second market research survey question from the plurality of market research survey questions to a second visual tile in the plurality of visual tiles.

16. The method of claim 9, the operations further comprising:
replacing visual tiles in the plurality of visual tiles as a user answers questions associated with the plurality of visual tiles, until an end condition of the market research survey is satisfied.

17. A graphical user interface (GUI) comprising:
a plurality of visual tiles arranged in a grid formation,
the GUI being configured to perform operations comprising:
detecting a user selection of a visual tile in the plurality of visual tiles; and
presenting a market research survey question from a plurality of market research survey questions in response to the user selection of the visual tile.

18. The GUI of claim 17, further configured to perform operations comprising:
presenting animations as a user answers questions associated with the plurality of visual tiles.

19. The GUI of claim 17, further configured to perform operations comprising:
presenting an animation in the GUI indicating completion of the game objective, the game objective comprising one or more of (a) answering market research survey questions for an entire row of visual tiles in the grid or (b) answering market research survey questions for an entire column of visual tiles in the grid.

20. The GUI of claim 17, further configured to perform operations comprising:
replacing visual tiles in the plurality of visual tiles as a user answers questions associated with the plurality of visual tiles, until an end condition of the market research survey is satisfied.
